(19) United States
(12) Patent Application Publication
(10) Pub. No.: US 2008/0144896 A1
(43) Pub. Date: Jun. 19, 2008

(54) ONLINE SYSTEM AND METHOD FOR PROVIDING INTERACTIVE MEDICAL IMAGES

(75) Inventor: Sean B. Burke, Milwaukee, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/555,095

(22) Filed: Oct. 31, 2006

(51) Int. Cl. G06K 9/00

(52) U.S. Cl. 382/128

(57) ABSTRACT

An online method for providing interactive medical images over a communication network includes receiving a request from a client computer via the communication network for a diagnostic imaging modality image. The diagnostic imaging modality image is retrieved from a database. A user interface is generated and is configured to display the diagnostic imaging modality image. The user interface also includes navigation controls for navigating the diagnostic imaging modality. The diagnostic imaging modality image and the user interface are then transmitter via the communication network to the client computer. The communication network may be the Internet and the user interface may be a Web page.

### FIELD OF THE INVENTION

The present invention relates generally to the field of computer and communication systems and in particular, to an online system and method for providing interactive medical images.

### BACKGROUND OF THE INVENTION

Health related information may be provided online via news web sites, medical web sites, online portals, etc. Patients and consumers are increasingly looking for information about health, disease, treatments and medical breakthroughs. Often, however, the information provided is either not accompanied by a visual image of the body part, disease, breakthrough, etc. or only accompanied by a static image of the body part, disease, breakthrough, etc.

A wide variety of diagnostic imaging systems have been developed and are presently in use in the medical field. Diagnostic imaging systems may be generally categorized by modality, with each modality being characterized by the underlying physics involved in acquisition of image data and reconstruction of the data into a useful image, control, utility and so forth. Diagnostic imaging systems include, for example, magnetic resonance imaging (MRI) systems, computer tomography (CT) imaging systems, conventional and digital X-ray systems, positron emission tomography (PET) systems, ultrasound systems, and so forth. Such systems have become refined in producing high quality and reliable images of, for example, internal organs, tissues, bones, etc., in various orientations within a subject of interest.

MRI systems are useful for producing images of, for example, a wide range of soft tissues. MRI systems may be used to, for example, diagnose nervous system disorders, identify brain tumors, diagnose pituitary gland diseases, identify blood vessel blockages, detect breast cancer, identify degenerative bone disorders and identify functional disorders in organs. CT systems are useful for producing images of, for example, organs, bones and other tissues. CT systems may be used to, for example, identify tumors, identify muscle and bone disorders, identify blood clots, identify heart disease, detect internal bleeding and guide other medical procedures. X-ray systems are useful for producing images of, for example, the chest, bones, joints and abdomen. X-ray systems may be used to, for example, determine whether a bone is broken, diagnose degenerative conditions, identify lung disease, identify heart disease, evaluate abdominal pain and locate tooth cavities. Ultrasound systems are useful for producing images of, for example, internal organs. Ultrasound systems may be used to, for example, evaluate a fetus, guide a needle biopsy, diagnose cancer, guide the treatment of a tumor and evaluate the heart.

It would be advantageous to provide an online system and method for providing interactive medical images. In particular, it would be advantageous to provide an Internet-based tool for accessing and navigating interactive medical images generated by various diagnostic imaging systems.

### BRIEF DESCRIPTION OF THE INVENTION

In accordance with an embodiment, an online method for providing interactive medical images over a communication network includes receiving a request from a client computer via the communication network for a diagnostic imaging modality image, retrieving the diagnostic imaging modality image from a database, generating a user interface configured to display the diagnostic imaging modality image and including navigation controls for navigating the diagnostic imaging modality image, and transmitting the diagnostic imaging modality image and the user interface via the communication network to the client computer.

In accordance with another embodiment, an online system for providing interactive medical imaging images over a communication network includes a first user interface configured to receive user input including a request for a diagnostic imaging modality image, a database configured to store a plurality of diagnostic imaging modality images, and a server coupled to the first user interface via the communication network and coupled to the database, the server configured to retrieve the requested diagnostic imaging modality image and to generate a second user interface, the second user interface configured to display the diagnostic imaging modality image and including navigation controls for navigating the diagnostic imaging modality image.

### BRIEF DESCRIPTION OF THE DRAWINGS

The invention will become more fully understood from the following detailed description, taken in conjunction with the accompanying drawings, in which:

FIG. 1 is a schematic block diagram of a system for providing interactive medical images in accordance with an embodiment.

FIG. 2 is a schematic block diagram of a system for providing interactive medical images in accordance with an alternative embodiment.

FIG. 3 is an exemplary user interface including a menu for selecting interactive medical images in accordance with an embodiment.

FIG. 4 is an exemplary user interface configured to allow navigation of an interactive medical image in accordance with an embodiment.

FIG. 5 is an exemplary user interface configured to allow navigation of an interactive medical image in accordance with an embodiment.

FIG. 6 is an exemplary screen including a link to a tool to provide interactive medical images in accordance with an embodiment.

FIG. 7 is an exemplary user interface configured to allow navigation of an interactive medical image in accordance with an embodiment.

FIG. 8 is a flowchart illustrating an online method for providing interactive medical images in accordance with an embodiment.

### DETAILED DESCRIPTION

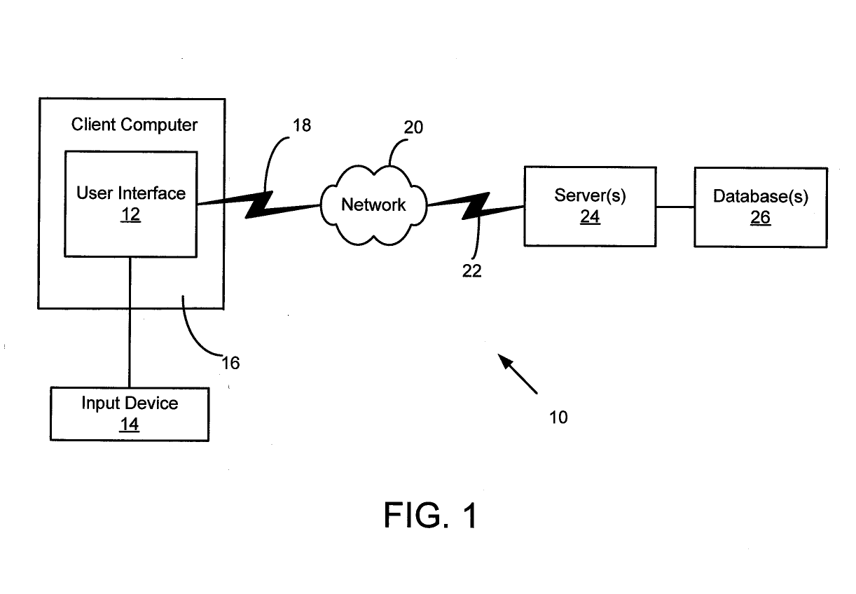

FIG. 1 is a schematic block diagram of a system for providing interactive medical images in accordance with an embodiment. System 10 includes a user interface 12, a network 20, server(s) 24 and database(s) 26. System 10 is configured to allow a user to access, view and navigate medical images, in particular, medical images generated by diagnostic imaging systems. User interface 12 may be implemented on a client computer 16 having a conventional input device 14 and a display (not shown). Client computer 16 can be any type of computing device including, for example, workstations, laptops, desktops, notebooks, personal digital assistants (PDA's), other hand-held devices, etc. Client computer may include a processor (not shown) and a memory (not shown) including volatile and nonvolatile memory. Client computer 16 may utilize existing computer capabilities, both hardware and software and may operate under the control of computer software to carry out the process steps described herein. Input device 14 may be, for example, a mouse, joystick, keyboard, track ball, touch activated screen, light wand, voice control, or any similar or equivalent input device.

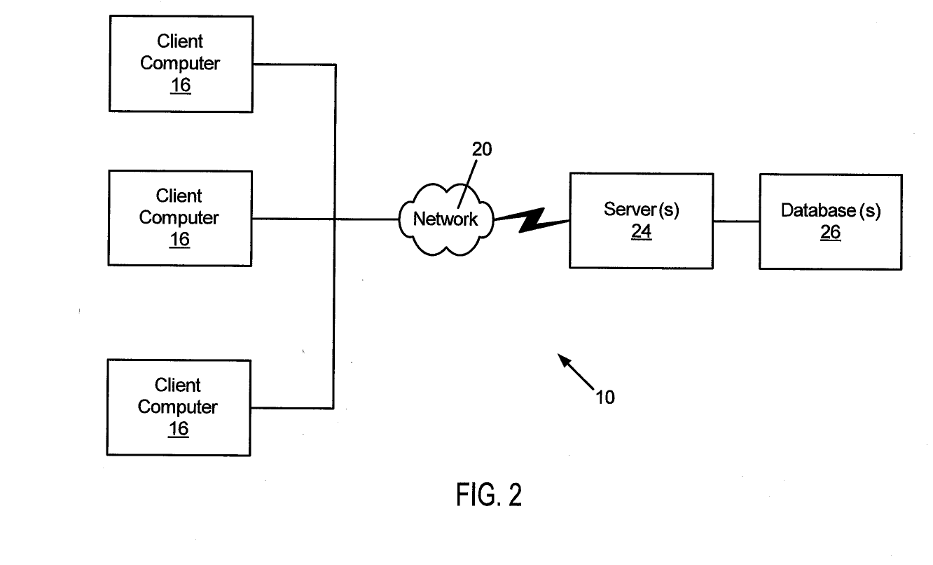

User interface 12 is coupled to a server or servers 24 via a network 20 and communication links 18, 22. User interface 12 may be used to request, view and navigate interactive medical images. User interface 12 may be used to access server 24 in order to request and receive interactive medical images as well as to receive and view user interface screens configured to allow a user to view and navigate the medical images. Although a single client computer 16 and user interface 12 is shown in FIG. 1, in another embodiment, multiple client computers 16 may be coupled to server 24 via network 20 and communication links 18, 22 as shown in FIG. 2. Accordingly, multiple users may access server 24 via a user interface (not shown) on each client computer 16.

Returning to FIG. 1, communication links 18, 22 may be hardwired links, wireless links or a combination of hardwired and wireless links. Network 20 may be any type of known communication networks, including but not limited to, a wide area network (WAN), a local area network (LAN), a global network (e.g., the Internet), and an intranet. Server 24 is coupled by network 20 to client computer 16 and user interface 12. Server 24 is a computer server having a processor (not shown) and a memory (not shown) including volatile and nonvolatile memory. Server 24 may utilize existing computer capabilities, both hardware and software and may operate under the control of computer software to carry out the process steps described above. Server 24 is configured to generate and provide one or more user interface screens. In addition, server 24 is configured to provide interactive medical images. Accordingly, server 24 is coupled to a database or database 26 that are configured to store medical images. In one embodiment, the medical images stored in database 26 are generated using diagnostic imaging systems including, but not limited to, magnetic resonance imaging (MRI) systems, computed tomography (CT) imaging systems, conventional and digital x-ray systems, positron emission tomography (PET) systems, ultrasound systems, and so forth. The medical images may include, for example, images of organs, bones, tissues, diseases, treatments, etc. Database 26 may be stored on the server 24, but can also be stored on another computer that is connected to and accessible by the server computer 24.

As mentioned, user interface 12 may be used to request, view and navigate interactive medical images. Accordingly, user interface 12 is configured to display various user interface screens and to access server 24. In one embodiment, user interface 12 may be configured to display Web pages, Web sites, Web portals, etc. Accordingly, computer 16 may include a browser application capable of accessing server 24, receiving data from a user and displaying Web pages over network 20. A browser application is typically a special-purpose application program configured to request Web pages and display Web pages. The browser application may be, for example, an application such as Internet Explorer sold by Microsoft Corporation of Redmond, Wash. or Netscape Navigator sold by Netscape Communications, Inc. of Mountain View, Calif.

A user may request a medical image from server 24 via user interface 12 and network 20. A user may be provided with a user interface screen having a menu or a search field to locate and request a medical image. FIG. 2 is an exemplary user interface including a menu for selecting interactive medical images in accordance with an embodiment. User interface screen 300 includes various menu items or links that may be selected by a user to find and request a medical image. For example, to view an image based on a particular disease, a user may select the link DISEASE 302. In one embodiment, the selection of the DISEASE link 302 will result in another screen or screens (not shown) to be displayed that allows a user to further define the medical image by the particular disease (e.g., heart disease, cancer, emphysema, etc.), the imaging modality for the image (e.g., MRI, CT, ultrasound, X-ray etc.), a particular organ or body part (e.g., heart, knee, lungs, etc.), and so forth. To view an image based on a particular organ or body part, a user may select the link ORGAN/BODY PART 304. The selection of the ORGAN/BODT PART link 304 may result in another screen or screens (not shown) to be displayed that allows a user to further define the medical image by the particular organ or body part (e.g., heart, knee, lungs, etc.), a particular disease (e.g., heart disease, cancer, emphysema, etc.), the imaging modality for the image (e.g., MRI, CT, ultrasound, X-ray etc.), and so forth. To view an image based on a particular treatment, a user may select the link TREATMENT 306. The selection of the TREATMENT link 306 may result in another screen or screens (not shown) to be displayed that allows a user to further define the medical image by the particular treatment, a particular organ or body part (e.g., heart, knee, lungs, etc.), a particular disease (e.g., heart disease, cancer, emphysema, etc.), the imaging modality for the image (e.g., MRI, CT, ultrasound, X-ray etc.), and so forth. To view an image based on a particular diagnostic imaging modality (e.g., MRI, CT, etc.), a user may select the link DIAGNOSTIC IMAGIGN MODALITY 308. The selection of the DIAGNOSTIC IMAGIGN MODALITY link 308 may result in another screen or screens (not shown) to be displayed that allows a user to further define the medical image by the particular diagnostic imaging modality, a particular organ or body part (e.g., heart, knee, lungs, etc.), a particular disease (e.g., heart disease, cancer, emphysema, etc.), and so forth. To view an image based on a medical breakthrough, a user may select the link MEDICAL BREAKTHROUGH 310. The selection of the MEDICAL BREAKTHROUGH link 310 may result in another screen or screens (not shown) to be displayed that allows a user to further define the medical image by the particular medical breakthrough, a particular organ or body part (e.g., heart, knee, lungs, etc.), a particular diagnostic imaging modality, and so forth.

Alternatively, a user may utilize a search field 312 to enter search criteria to find a medical image. Once the search criteria are entered into search field 312, the user may select a button 314 to submit the search criteria. The results of the search may be displayed on the user interface 12 (shown in FIG. 1)

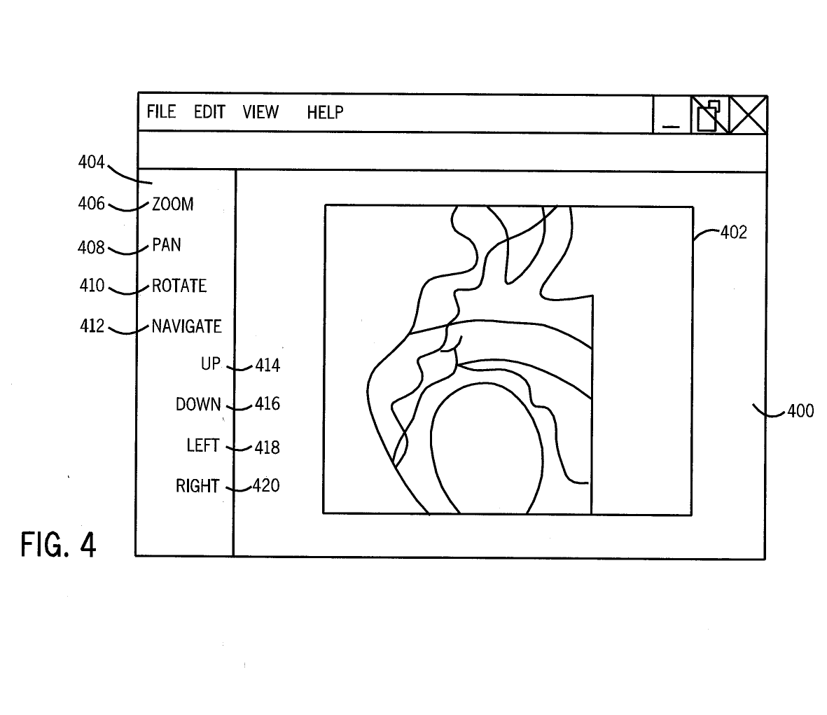

Returning to FIG. 1, when a medical image is selected, a request is sent from user interface 22 to server 24. Server 24 retrieves the image from database 26 and transmits the image to user interface 12. In one embodiment, server 24 also generates and transmits a user interface screen(s) that is configured to allow a user to view and navigate the requested image. FIG. 4 is an exemplary user interface configured to allow navigation of an interactive medical image in accordance with an embodiment. User interface screen 400 may be provided (e.g., by server 24 or client computer 16, both shown in FIG. 1) when a user selects or requests a particular medical image. User interface screen 400 displays an image 402 and includes a navigation toolbar 404 that has various controls that may be used to navigate and manipulate the image 402. In this exemplary embodiment, image 402 is a three-dimensional CT image of a heart. A user may navigate the image 402 by selecting a control from the navigation toolbar 404. For example, a user may zoom 406 or pan 408 an image to view details of the image. A user may rotate or flip the image 402 by selecting (e.g., clicking) the rotate 410 control. A user may also navigate 412 the image 402 using the controls up 414, down 416, left 418 and right 420. As mentioned, preferably, the medical images (e.g., medical images stored in database 26 shown in FIG. 1) are images generated using various diagnostic imaging system or modalities.

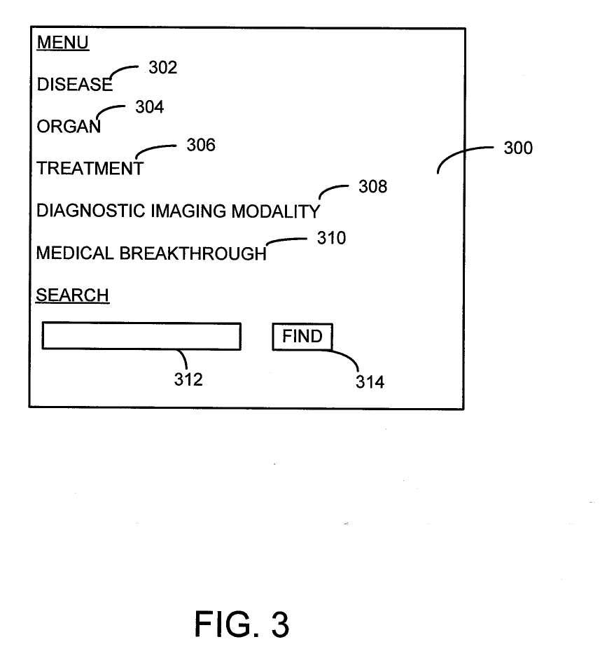

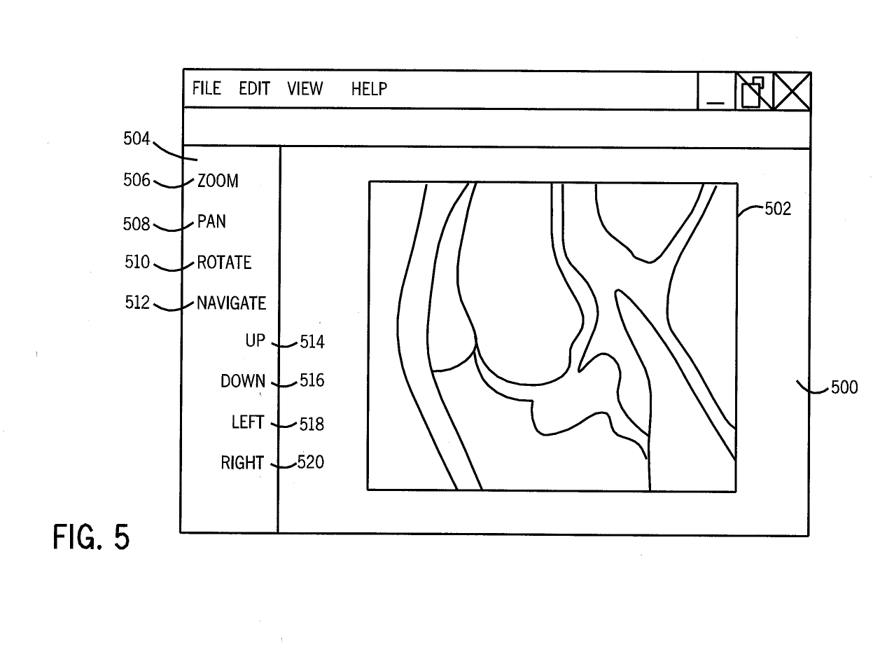

FIG. 5 is an exemplary user interface configured to allow navigation of an interactive medical image in accordance with an embodiment. In the exemplary embodiment of FIG. 5, an MRI image 502 of a knee is displayed in user interface screen 500. The image 502 may be selected by a user via a menu or a search as described above with respect to FIG. 3. A navigation toolbar 504 may be used to navigate an manipulate the image 502 using various controls including zoom 506, pan 508, rotate 510, up 514, down 516, left 518 and right 520.

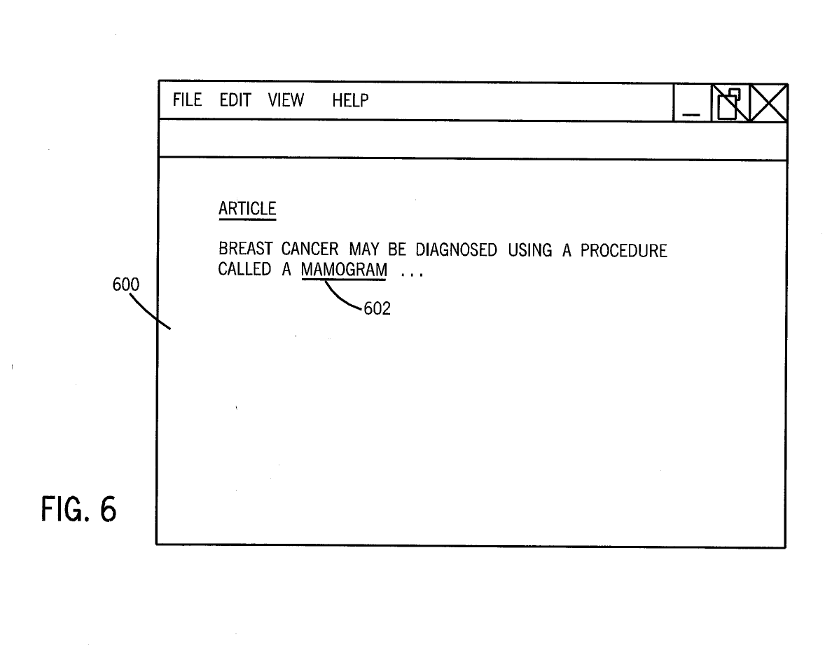

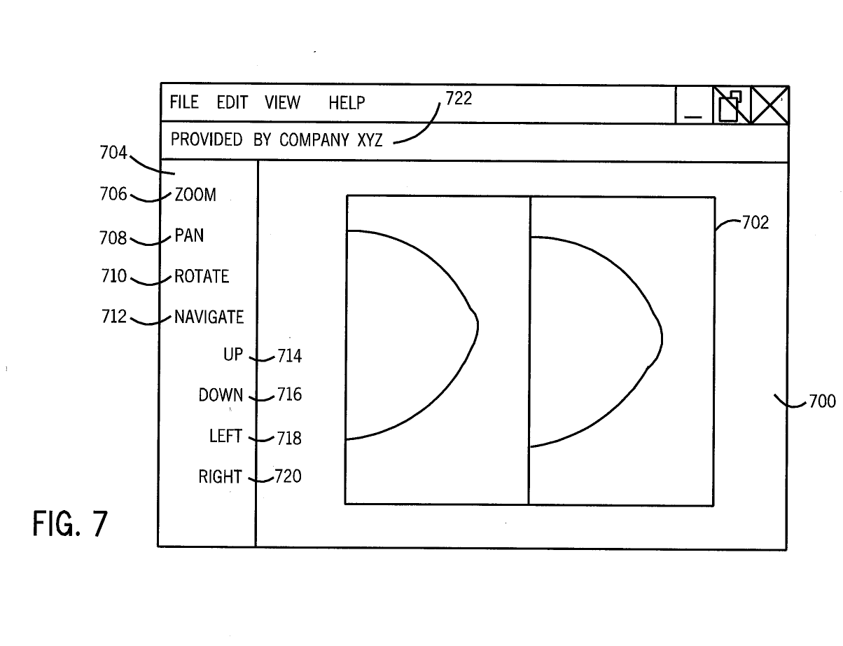

In another embodiment, medical images and the user interface(s) or tool (e.g., as provided by server 24 and database 26 shown in FIG. 1) used to view and navigate the medical images may be accessed via links provided on a Web site, Web page or portal operated by a third party. FIG. 6 is an exemplary screen including a link to a tool to provide interactive medical images in accordance with an embodiment. Screen 600 may be part of, for example, a Web site or portal provided and maintained by a third party. A link 602 may be provided in text or key words on the third party site, for example, an article, a definition, etc. Link 602 may be associated with a Uniform Resource Locator (“URL”) or IP address that uniquely identifies server 24 (shown in FIG. 1). Accordingly, link 602 may be used to access server 24 and to launch a user interface screen or screens that display an image related to the term or text. In the exemplary screen in FIG. 6, a link 602 is provided on the term “mammogram.” When a user selects the link 602 (e.g., clicks on the link), server 24 (shown in FIG. 1) is accessed and provides a user interface screen(s) to display and navigate a mammography image. FIG. 7 is an exemplary user interface configured to allow navigation of an interactive medical image in accordance with an embodiment. In FIG. 7, a mammography image 702 is displayed in user interface screen 700. As mentioned, user interface screen 700 may be launched in response to the selection of link 602 (shown in FIG. 6). A navigation toolbar 704 may be used to navigate an manipulate the image 702 using various controls including zoom 706, pan 708, rotate 710, up 714, down 716, left 718 and right 720.

In another embodiment, user interface 700 may be brandable or customizable to allow a party (e.g., a party that owns and/or operates server 24 and database 26, both shown in FIG. 1) to insert a customizable message, to provide additional “branding” or customization, naming, trademark and logos, etc. The user interface may be branded by providing regions (e.g., region 722) that are configurable by a party to include, for example, trademarks, logos of the party, content provided by the party, graphics related to the party, etc. For example, user interface screen 700 includes a region 722 that indicates the content is “Provided by Company XYZ.” In addition, the user interface screen 700 may be customizable so that a party may include their own fonts, color schemes and text message to provide the user interface screen 700 with a “look and feel” that is consistent with the corporate identity of the party.

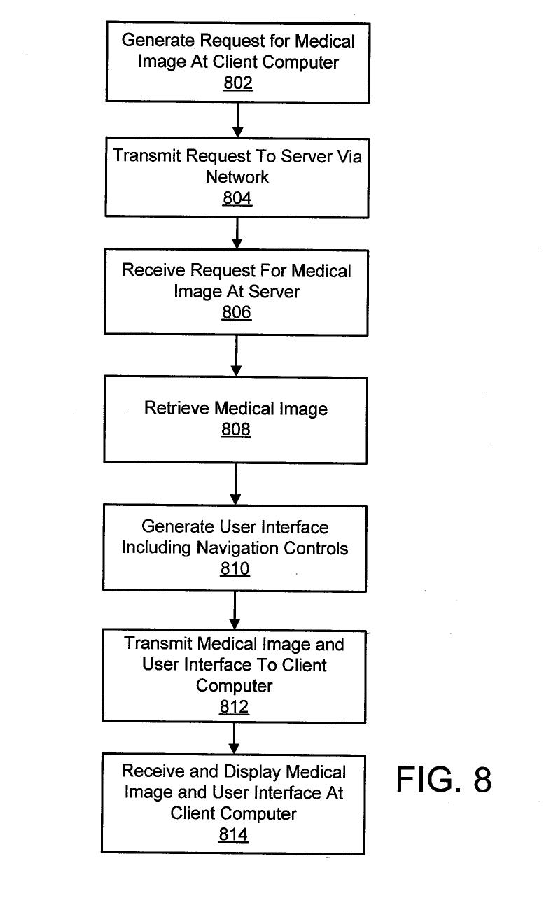

FIG. 8 is a flowchart illustrating an online method for providing interactive medical images in accordance with an embodiment. At block 802, a request for a medical image is generated at a client computer. As discussed above, preferably the medical image is an image generated by a diagnostic imaging system or modality such as MRI, CT, X-ray, ultrasound, etc. The request may be received from a user via a user interface including, for example, a menu, a search function, etc. Alternative, as discussed above with respect to FIG. 6, a link may be provided on a third party Web site or portal that provides access to the medical image and online tool. At block 804, the request is transmitted to a server via a communication network such as the Internet. When the server receives the request at block 806, the server retrieves the medical image at block 808 from, for example, a database and generates a user interface having navigation controls at block 810. As discussed above, the user interface is configured to display the medical image and to allow a user to navigate the requested image. Navigation controls may include for example, zoom, pan, rotate, up, down, left and right. The server then transmits the medical image and user interface to the client computer over the network at block 812. The user interface may be, for example, a Web page. At block 814, the client computer receives the medical image and user interface and displays the medical image and user interface. A user may then view and navigate the medical image using the user interface.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass may types of computer system configurations, including personal computers, hand-held devices, multi-processor systems, microprocessor-based or programmable consumer electronics, network PC's minicomputers, mainframe computers, and the like. Embodiments may also be practiced in distributed computing environments where tasks are performed by local and remote processing devices that are linked (either by hardwired links, wireless links or by a combination of hardwired or wireless links) through a communications network. In a distributed computing environment, program modules may be located in both local and remote memory storage devices.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order and sequence of any process or method steps may be varied or re-sequenced according to alternative embodiments.

Many other changes and modifications may be made to the present invention without departing from the spirit thereof. The scope of these and other changes will become apparent from the appended claims.

We claim:

1. An online method for providing interactive medical images over a communication network, the method comprising:
receiving a request from a client computer via the communication network for a diagnostic imaging modality image;
retrieving the diagnostic imaging modality image from a database;
generating a user interface configured to display the diagnostic imaging modality image and including navigation controls for navigating the diagnostic imaging modality image; and
transmitting the diagnostic imaging modality image and the user interface via the communication network to the client computer.

2. An online method according to claim 1, wherein the communication network is the Internet.

3. An online method according to claim 1, wherein the user interface is a Web page.

4. An online method according to claim 1, wherein the diagnostic imaging modality image is one of a MRI image, a CT image, an X-ray image and an ultrasound image.

5. An online method according to claim 1, wherein the navigation controls include at least one of zoom, pan, rotate and navigate.

6. An online method according to claim 1, wherein the user interface includes at least one configurable region for including branding information.

7. An online method according to claim 1, wherein the request is generated by a user selecting a link on a Web page displayed on the client computer, the Web page associated with a third party.

8. An online system for providing interactive medical imaging images over a communication network, the system comprising:
a first user interface configured to receive user input including a request for a diagnostic imaging modality image;
a database configured to store a plurality of diagnostic imaging modality images; and
a server coupled to the first user interface via the communication network and coupled to the database, the server configured to retrieve the requested diagnostic imaging modality image and to generate a second user interface, the second user interface configured to display the diagnostic imaging modality image and including navigation controls for navigating the diagnostic imaging modality image.

9. An online system according to claim 8, wherein the communication network is the Internet.

10. An online system according to claim 8, wherein the second user interface is a Web page.

11. An online system according to claim 8, wherein the diagnostic imaging modality image and the second user interface are transmitter via the communication network to a client computer.

12. An online system according to claim 8, wherein the diagnostic imaging modality image is one of a MRI image, a CT image, an X-ray image and an ultrasound image.

13. An online system according to claim 8, wherein the navigation controls include at least one of zoom, pan, rotate and navigate.

14. An online system according to claim 8, wherein the second user interface includes at least one configurable region for including branding information.

15. An online system according to claim 8, wherein the request is generated by a user selecting a link on a Web page displayed on the first user interface, the Web page associated with a third party.
